(19) United States
(12) Patent Application Publication
(10) Pub. No.: US 2020/0079490 A1
(43) Pub. Date: Mar. 12, 2020

(54) SYSTEM FOR SECURING A GLAZING TO THE VEHICLE STRUCTURE

(71) Applicant: SAINT-GOBAIN GLASS FRANCE, COURBEVOIE (FR)

(72) Inventors: Youness BELHIOUANE, LE TOUVET (FR); Benoît LUBIN, OUZOUER SUR LOIRE (FR); Florian BRUGGEMAN, AUBIGNY SUR NERE (FR)

(21) Appl. No.: 16/608,412

(22) PCT Filed: Apr. 24, 2018
(86) PCT No.: PCT/FR2018/051023

§ 371 Date: Oct. 25, 2019

(30) Foreign Application Priority Data
Apr. 28, 2017 (FR) 1753805

(51) Int. Cl. B64C 1/14

(52) U.S. Cl. CPC B64C 1/1492; B64C 1/1484

(57) ABSTRACT

A system for securing glazing to the structure of a vehicle, includes an exterior first primary half-frame and an interior second primary half-frame, the first and second primary half-frames and being fixed together, and the assembly that they form is secured to the structure of the vehicle. Each of the first and second primary half-frames are made up of at least n and m parts, respectively, fixed in consecutive pairs, where n and m are identical or different whole numbers at least equal to 2. The junctions between the parts of the first primary half-frame and of the second primary half-frame, respectively, are offset with respect to one another.

The invention relates to the mounting of glazing on the structure of a vehicle, such as the body of a motor vehicle, or preferably here, the cabin of an aircraft.

In order to secure glazing to the structure of a vehicle, it is known practice to use a first primary half-frame for locking the first main face of the glazing that is intended to be oriented toward the outside of the vehicle, and a second primary half-frame for locking the second main face of the glazing that is intended to be oriented toward the inside of the vehicle, the first and second primary half-frames being fixed together, and the assembly that they form being secured to the structure of the vehicle by gripping and screwing or the like.

Each primary half-frame is manufactured by machining a block of constituent material, in particular aluminum. Since the half-frame has relatively large dimensions and consists substantially of empty space, the percentage of material loss to be eliminated is high, greater than 90% for example. The inventors have considered how to reduce this material loss, while ensuring the rigidity required for each primary half-frame.

This aim is achieved by the invention, the subject of which, consequently, is a system for securing glazing to the structure of a vehicle, comprising a first primary half-frame for locking the first main face of the glazing that is intended to be oriented toward the outside of the vehicle, and a second primary half-frame for locking the second main face of the glazing that is intended to be oriented toward the inside of the vehicle, the first and second primary half-frames being fixed together, and the assembly that they form being secured to the structure of the vehicle, characterized in that each of the first and second primary half-frames is made up of at least two parts by the latter being fixed in consecutive pairs for each of the first and second primary half-frames, and in that the projections of the junctions between the parts of the first primary half-frame and of the second primary half-frame, respectively, onto the second primary half-frame and the first primary half-frame, respectively, do not coincide with the junctions between the parts of the second primary half-frame and of the first primary half-frame, respectively.

As mentioned above, the vehicle is in particular an aircraft, such as an airplane. The securing of glazing to this type of vehicle is particularly demanding, given the extreme use conditions, the wide range of temperatures down to extremely low values, and especially the pressure difference between the interior and exterior atmospheres of the vehicle. This securing may comprise various bolted connections in particular.

The first and second primary half-frames are fixed together by screwing or the like, so as to enclose, grip the glazing.

For the primary half-frame, the constituent parts are smaller than the whole; they can be machined from blocks of aluminum with smaller volumes, all the more so given that their exterior surface has much less in the way of concave parts (and thus much less empty space), or can even be substantially rectilinear. The loss of constituent material is considerably reduced.

According to further preferred features of the securing system of the invention:
the second primary half-frame is directly fixed to the structure of the vehicle, for example by screwing or the like;
the second primary half-frame is fixed to a secondary frame which is fixed to the structure of the vehicle, again for example by screwing or the like; in this particular embodiment, the secondary frame may be movable (sliding etc.) with respect to the structure of the vehicle;
the consecutive parts of the first primary half-frame, and/or the consecutive parts of the second primary half-frame are joined in pairs by fitting together complementary shapes: mortise-tenon, inverted step shape, dovetail, etc. as will be seen in more detail below;
the consecutive parts of the first primary half-frame, and/or the consecutive parts of the second primary half-frame are fixed in pairs by bonding, by screwing (or the like), or even by both at the same time; for the bonding, use can be made of a glue that provides leaktightness with respect to liquids and gases between the consecutive parts of the primary half-frame;
the whole numbers n and/or m are at least equal to 3, preferably to 4.

The invention will be understood better in the light of the following description of the appended drawings, in which:

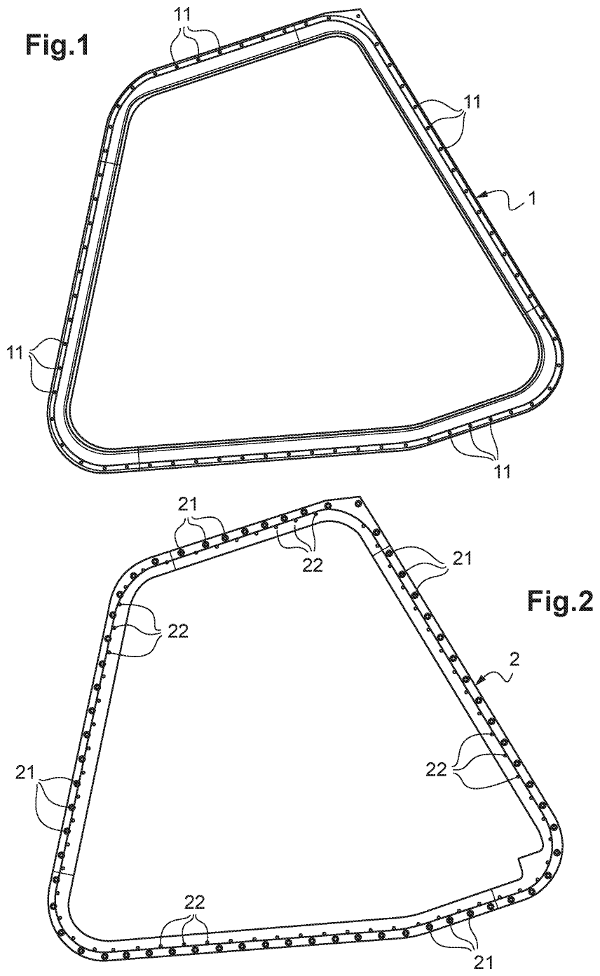

FIG. 1 is a side view intended to be on the outside of the vehicle of a first primary half-frame for locking the first face of glazing that is intended to be oriented toward the outside of the vehicle, in the mounted position of the glazing;

FIG. 2 is a side view intended to be on the outside of the vehicle of a second primary half-frame for locking the second face of glazing that is intended to be oriented toward the inside of the vehicle, in the mounted position of the glazing;

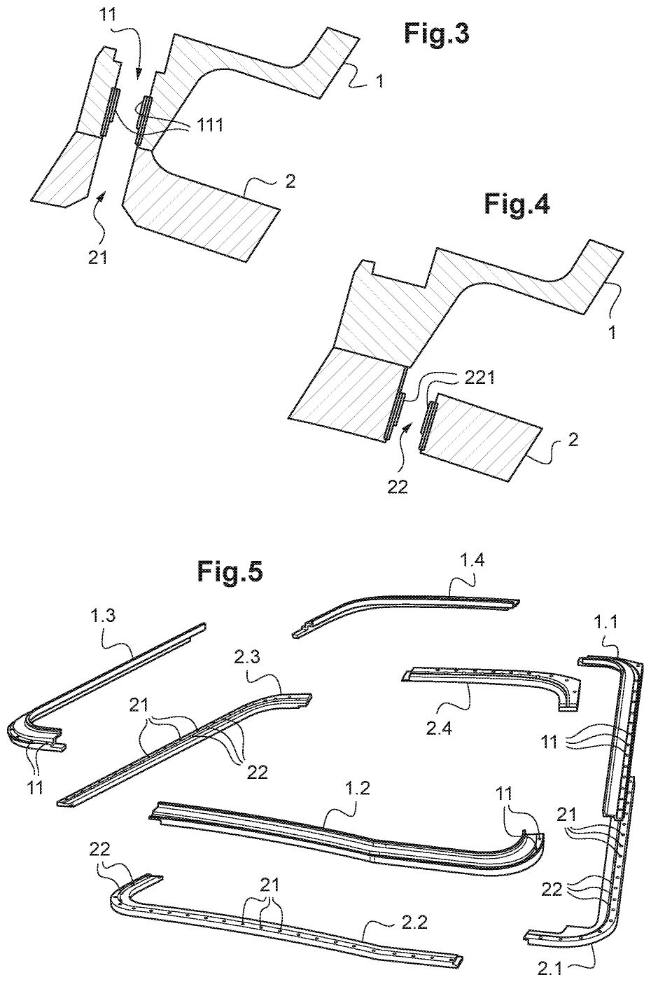

FIG. 3 is a partial cross section of a first and a second primary half-frame, illustrating the screwing thereof;

FIG. 4 is a partial cross section of a first and a second primary half-frame, illustrating the screwing of the second primary half-frame to the structure of a vehicle;

FIG. 5 shows, in a position preceding assembly, the four parts of a first primary half-frame and the four parts of a second primary half-frame, viewed in perspective;

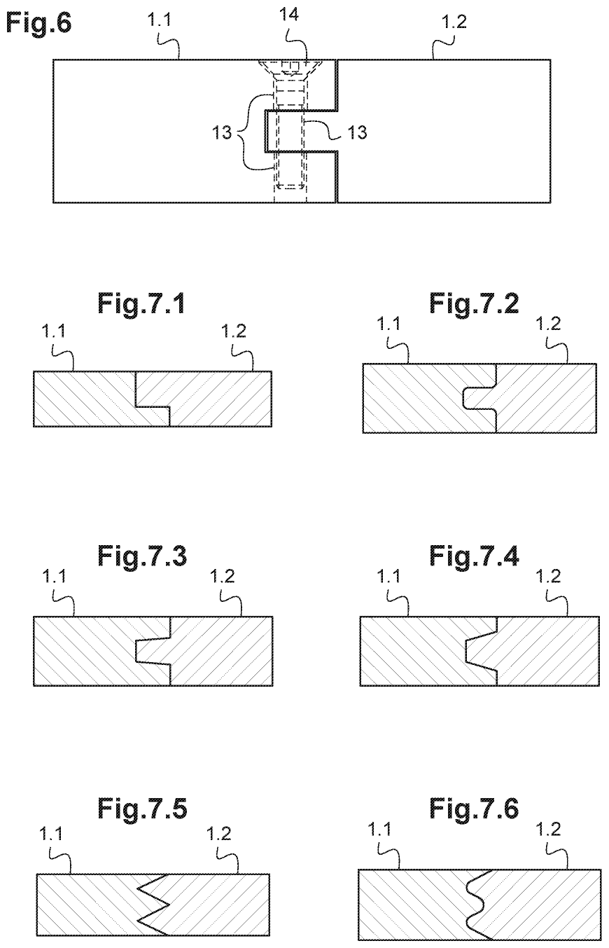

FIGS. 6, 7.1, 7.2, 7.3, 7.4, 7.5 and 7.6 are partial schematic depictions of the fixing of two consecutive parts of a first primary half-frame.

With reference to FIG. 1, a first primary half-frame 1 made of aluminum is provided with holes 11 for fixing by screwing or the like to a second primary half-frame.

In FIG. 2, a second primary half-frame 2 comprises holes 21 for fixing to a first primary half-frame, and holes 22 for fixing by screwing or the like to the structure of a vehicle (bodywork opening, cabin opening, etc.), either directly to this structure or to an intermediate secondary frame, which, if necessary, is movable (sliding etc.) with respect to the structure of the vehicle to which the secondary frame is itself intended to be fixed.

In FIG. 3, the holes 11 in the first primary half-frame 1 and 21 in the second primary half-frame 2, respectively, coincide for a screw to pass through. The introduction edges of the hole 21 and of the hole 11, respectively, are designed to receive a screw head, or a nut or a sealing gasket which are not shown. The hole 11 exhibits a thread (111).

In FIG. 4, the hole 22 in the second primary half-frame 2 is equipped with a thread (221).

In FIG. 5, the parts 1.1, 1.2, 1.3 and 1.4 are intended to form a first primary half-frame. Two consecutive ones of the parts 1.1, 1.2, 1.3 and 1.4 fit together by way of complementary shapes with inverted step shapes that are likewise shown in FIG. 7.1.

The parts 2.1, 2.2, 2.3 and 2.4 are intended to form a second primary half-frame, with a geometry that is, of course, compatible with/corresponds to that of the first primary half-frame.

Each part 1.1, 1.2, 1.3 and 1.4 of the first primary half-frame is provided with regularly spaced-apart holes 11 that are intended to cooperate with the holes 21 in the parts 2.1, 2.2, 2.3 and 2.4 of the second primary half-frame, with which they consequently coincide in the mounted state of the glazing in its two primary half-frames.

Each part 2.1, 2.2, 2.3 and 2.4 of the second primary half-frame is moreover equipped with regularly spaced-apart holes 22 likewise for fixing by screwing or the like to the structure of a vehicle.

The projections of the junctions between the parts (1.1, 1.2, 1.3, 1.4) of the first primary half-frame (1) and (2.1, 2.2, 2.3, 2.4) of the second primary half-frame (2), respectively, onto the second primary half-frame (2) and the first primary half-frame (1), respectively, do not coincide with the junctions between the parts (2.1, 2.2, 2.3, 2.4) of the second primary half-frame (2) and (1.1, 1.2, 1.3, 1.4) of the first primary half-frame (1), respectively. This disposition ensures the required rigidity of the assembly of the glazing gripped between its two primary half-frames.

The fixing of one of the parts 1.1 and 1.2 of a first primary half-frame to the other is shown in FIG. 6. The parts 1.1 and 1.2 fit together by way of complementary shapes of the mortise-tenon type. They are fixed by means of a screw 14 that engages with a thread 13 formed within each of the parts 1.1 and 1.2. Screwing can form the only means of fixing the parts 1.1 and 1.2, or it may be combined with bonding of their contact surfaces, or this bonding can form the only means of fixing, in the absence of the screw 14, the threads 13 and the bores in the parts 1.1 and 1.2 that are intended to receive the screw 14. A glue that provides leaktightness with respect to liquids and gases can be employed, for example a silicone glue.

FIGS. 7.1, 7.2, 7.3, 7.4, 7.5 and 7.6 show different examples of complementary shapes for fitting together the consecutive parts 1.1 and 1.2 (for example), the contact surfaces of which can be bonded so as to obtain the fixing of these parts 1.1 and 1.2 together.

1. A system for securing glazing to the structure of a vehicle, comprising a first primary half-frame for locking the first main face of the glazing that is intended to be oriented toward the outside of the vehicle, and a second primary half-frame for locking the second main face of the glazing that is intended to be oriented toward the inside of the vehicle, the first and second primary half-frames and being fixed together to form an assembly, and said assembly being secured to the structure of the vehicle, wherein the first primary half-frames is made up of n parts fixed in consecutive pairs, where n is a whole number greater than or equal to 2, and wherein the second primary half-frame is made up of m parts fixed in consecutive pairs, where m is a whole number greater than or equal to 2, where n and m are identical or different, and wherein projections of junctions between the parts of the first primary half-frame and of the second primary half-frame, respectively, onto the second primary half-frame and the first primary half-frame, respectively, do not coincide with the junctions between the parts of the second primary half-frame and of the first primary half-frame, respectively.

2. The system for securing glazing to the structure of a vehicle as claimed in claim 1, wherein the second primary half-frame is directly fixed to the structure of the vehicle.

3. The system for securing glazing to the structure of a vehicle as claimed in claim 1, wherein the second primary half-frame is fixed to a secondary frame which is fixed to the structure of the vehicle.

4. The system for securing glazing to the structure of a vehicle as claimed in claim 3, wherein the secondary frame is movable with respect to the structure of the vehicle.

5. The system for securing glazing to the structure of a vehicle as claimed in claim 1, wherein the consecutive parts of the first primary half-frame, or the consecutive parts of the second primary half-frame, or both, are joined in pairs by fitting together complementary shapes.

6. The system for securing glazing to the structure of a vehicle as claimed in claim 5, wherein the consecutive parts of the first primary half-frame, or the consecutive parts of the second primary half-frame, or both, are fixed in pairs by bonding.

7. The system for securing glazing to the structure of a vehicle as claimed in claim 5, wherein the consecutive parts of the first primary half-frame or the consecutive parts of the second primary half-frame, or both, are fixed in pairs by screwing or the like.

8. The system for securing glazing to the structure of a vehicle as claimed in claim 1, wherein the whole numbers n or m, or both, are at least equal to 3.

9. The system for securing glazing to the structure of a vehicle as claimed in claim 1, wherein the whole numbers n or m, or both, are at least equal to 4.
